(19) United States
(12) Patent Application Publication
(10) Pub. No.: US 2014/0197801 A1
(43) Pub. Date: Jul. 17, 2014

(54) SILICON-BASED ELECTRODE FOR A LITHIUM-ION CELL

(71) Applicants: Ralph G. Nuzzo, Champaign, IL (US); Jason L. Goldman, Savoy, IL (US); Michael W. Cason, Urbana, IL (US)

(72) Inventors: Ralph G. Nuzzo, Champaign, IL (US); Jason L. Goldman, Savoy, IL (US); Michael W. Cason, Urbana, IL (US)

(73) Assignee: The Board of Trustees of the University of Illinois, Urbana, IL (US)

(21) Appl. No.: 14/118,690

(22) PCT Filed: May 17, 2012
(86) PCT No.: PCT/US12/38245

§ 371 Date: Feb. 12, 2014

Related U.S. Application Data
(60) Provisional application No. 61/488,490, filed on May 20, 2011.

(51) Int. Cl. H01M 4/62; H02J 7/00

(52) U.S. Cl. CPC H01M 4/628; H02J 7/0052
USPC 320/137; 429/231.95; 429/215

(57) ABSTRACT

A silicon-based electrode includes a silicon layer on a substrate, an electrically conductive layer overlying a top surface of the silicon layer, an optional polymer layer overlying the top surface of the electrically conducting layer, and a plurality of channels extending through the electrically conductive layer and the silicon layer to the substrate. The channels define sidewalls in the silicon layer. The electrically conductive layer and the optional polymer layer act to inhibit lithium ion intercalation through the top surface of the silicon layer during charging of a lithium-ion cell, and the lithium ion intercalation into the silicon layer occurs through the sidewalls that are defined by the channels.

### FEDERALLY SPONSORED RESEARCH OR DEVELOPMENT

This invention was made with government support under DE-AC02-06CH11 awarded by the US Department of Energy (DOE). The government has certain rights in the invention.

### TECHNICAL FIELD

The present disclosure is related generally to an electrode for a rechargeable battery and more particularly to a silicon-based electrode for a Li-ion cell.

### BACKGROUND

Rechargeable lithium-ion batteries are a widely utilized form of energy storage that are critical for electric/hybrid electric vehicles, medical devices, and portable electronics. Energy is stored and released through electrochemical reactions of lithium ions at the anode and cathode. Typically, lithium ions are dissolved in non-aqueous electrolytes that also react with the surface of the anode and cathode, forming solid-electrolyte interphases/interfaces (SEI) within the range of electrochemical potentials at which batteries operate. Improvements to batteries are needed in terms of energy storage density, coulombic efficiency, and multi-cycle lifetime while maintaining low costs. Furthermore, as energy density increases—and larger amounts of energy are constrained to smaller spaces—safety may become a dominant issue, especially if these energy storage solutions see widespread, daily use. Materials for the anode and cathode of next-generation batteries must resist wear with continued usage (and abuse) to avoid explosive venting and fire. Anodes (or cathodes) that have material breaking away from the electrode below the pore size of the separator are of particular concern.

In order to achieve the goals stated above, higher capacity materials for the anode and cathode—relative to conventionally used carbon for anodes and LiCoO₂ for cathodes—are sought. Attaining higher energy storage densities in lithium-ion batteries has been inhibited by challenges inherent to confining more energy to smaller dimensions and also by safety concerns. While silicon is promising as an anode material due to its high theoretical gravimetric capacity (˜10 times greater than carbon), the material has been largely unusable due to the large strains (˜300% swelling) that occur during lithium insertion (charging), which may result in short operational lifetimes for the battery.

### BRIEF SUMMARY

An improved silicon-based electrode that may enable lithium ion cells with an increased energy density and minimal capacity loss is set forth herein. A lithium-ion cell and a method of charging the lithium-ion cell are also described.

The electrode includes a silicon layer on a substrate, an electrically conductive layer overlying a top surface of the silicon layer, and a plurality of channels extending through the electrically conductive layer and the silicon layer to the substrate. The channels define sidewalls in the silicon layer. The electrically conductive layer inhibits lithium ion intercalation through the top surface of the silicon layer during charging of a lithium-ion cell, and the lithium ion intercalation into the silicon layer occurs through the sidewalls defined by the channels.

The lithium-ion cell includes a first electrode, a second electrode, and an electrolyte in contact with the first electrode and the second electrode, wherein the electrolyte conducts lithium ions and the first electrode comprises a silicon layer on a substrate, an electrically conductive layer overlying a top surface of the silicon layer, and a plurality of channels extending through the electrically conductive layer and the silicon layer to the substrate. The channels define sidewalls in the silicon layer. The electrically conductive layer inhibits lithium ion intercalation through the top surface of the silicon layer during charging of the lithium-ion cell, and the lithium ion intercalation into the silicon layer occurs through the sidewalls defined by the channels.

The method of charging the lithium-ion cell entails providing a first electrode, a second electrode, and an electrolyte in contact with the first electrode and the second electrode, wherein the electrolyte conducts lithium ions and the first electrode includes a silicon layer on a substrate, an electrically conductive layer overlying a top surface of the silicon layer, and a plurality of channels extending through the electrically conductive layer and the silicon layer to the substrate. The channels define sidewalls in the silicon layer. Lithium ions are intercalated into the silicon layer through the sidewalls thereof, and the lithium ions are substantially blocked from intercalation through the top surface of the silicon layer. The method may further include forming a solid electrolyte interface layer on the sidewalls of the silicon layer. In addition, the channels may be aligned in a thickness direction substantially perpendicular to the top surface of the silicon layer, and the silicon layer may expand in the thickness direction during the intercalating.

### BRIEF DESCRIPTION OF THE DRAWINGS

FIG. 1a is a schematic of an exemplary high capacity multilayer polyethylene/copper/silicon (PE/Cu/Si) micropore-modified anode that includes a silicon layer, a copper layer on the silicon layer, and a polymer layer on the copper layer, where channels extend through the three layers;

FIG. 1b is a cross-sectional schematic of the anode of FIG. 1a that illustrates lithium ion transport into the silicon layer, where the lithium ions are blocked from the top surface of the silicon and intercalate through sidewalls defined by the channels;

FIG. 1c is a cross-section schematic illustrates a proposed scheme of operation for the anode, where SEI formation in the channels and the fixing of the anode to a substrate allow for significant expansion in the thickness (z) direction;

FIG. 1d is a top down scanning electron microscope (SEM) image of a PE/Cu/Si anode before charge/discharge cycling, where the inset shows a magnified image of one of the channels; in the inset, small fragments of polymer are still visible on the edge of the hole where it was removed;

FIG. 1e is a top down SEM image of a PE/Cu/Si anode after 125 galvanostatic charge/discharge cycles at 280 mA/g at C/5, where the charging or discharging occurs in 5 hours;

FIG. 2a shows an exemplary process flow for fabricating multilayer anodes including an electrically conductive layer (e.g., copper), where silicon on Insulator (SOI) wafers are patterned, etched, and HF undercut to result in a thin silicon layer that is coated on both sides by copper;

FIG. 2b shows additional exemplary process flow steps to coat the top surface of the anodes of FIG. 2a with a polymer; the polymer is etched in an oxygen plasma using the silicon and copper as an etch mask;

FIG. 2c shows optical and SEM images of a 4 μm thick device with a channel array pitch of 1.15 before charge/discharge cycling; the semi-transparency is a result of the array of 6 μm diameter channels;

FIG. 2d shows top-down SEM images of samples with different array pitches, where the choice of photolithography mask before etching of the silicon device layer allows for a variety of different array pitches, and the smallest array pitch had an edge-to-edge spacing between the channels that was 18 times smaller than the largest array pitch;

FIG. 2e shows exemplary silicon samples having different form factors, a thin silicon ribbon that can be employed in a three-electrode or prismatic cell (top), and a circular silicon sample that can be employed in a coin cell (bottom);

FIG. 3a shows capacity retention for a multilayer PE/Cu/Si anode in a three electrode cell with a lithium metal cathode galvanostatically (constant current) charge/discharge cycled at 280 mA/g (C/5), where the discharge capacity per weight (gravimetric discharge capacity) has minimal degradation over 125 charge/discharge cycles. The retained capacity of this multilayer electrode is more than 3 times greater than the theoretical capacity of conventional carbon anodes denoted by the dashed line;

FIG. 3b shows, for the three electrode cell of FIG. 3a, the ratio of energy in to energy out (coulombic efficiency) for galvanostatic (constant current) charge/discharge cycling between 2.0 V and 0.01 V;

FIG. 3c shows, for the three electrode cell of FIG. 3a, voltage (vs. Li/Li⁺) vs. time for galvanostatic (constant current) charge/discharge cycling between 2.0 V and 0.01 V. Voltage profiles are shown for charge/discharge cycles 25 through 125;

FIG. 4a shows capacity retention for an exemplary multilayer Cu/Si/Cu anode in a coin cell with a LCO cathode galvanostatically (constant current) charge/discharge cycled at 280 mA/g (C/5); >99% of the initial discharge capacity remains on the 90^{th} cycle—the battery is continuing to charge/discharge cycle;

FIG. 4b shows the ratio of energy in to energy out (coulombic efficiency), for the exemplary Cu/Si/Cu anode and LCO cathode shown in FIG. 4a. The average coulombic efficiency over the 10^{th} to the 90^{th} cycle is >99%;

FIG. 4c shows cell voltage versus time for galvanostatic charge/discharge cycling between 3.0 V and 4.2 V of the battery shown in FIG. 4a with a standard LCO cathode. Voltage profiles are shown for charge/discharge cycles 10 through 90;

FIG. 4d shows an image of Li-ion coin cells on an 8 channel cycler;

FIG. 4e shows a schematic of a Li-ion coin cell;

FIG. 5 shows the total capacity achieved in functional devices as a function of silicon film thickness, obtained from cycling of coin cells with (Cu/Si/Cu) layered anodes (channel array pitch of 1.15) versus lithium metal cathodes. For clarity, the data were normalized to the sample area. The 4 micron and 20 micron, and 50 micron samples were galvanostatically charge/discharge cycled at C/5;

FIG. 6a shows the capacity per volume versus maximum achievable current density during stable, continuous charge/discharge cycling for Cu/Si/Cu anodes with various channel array pitches. Channel array pitch (inset)—the ratio of edge-to-edge distance between channels (dashed white line) to the channel diameter (white line)—was measured utilizing scanning electron microscopy. The silicon layer was 4 μm thick and had CAPs of 0.21 (red left-facing arrow), 1.15 (green diamond), and 3.72 (blue right-facing arrow). The black square represents a typical carbon anode. Samples were galvanostatically charge/discharge cycled at various current densities between 2.0 V and 0.01 V;

FIG. 6b shows the gravimetric capacity of the multilayer anode at various continuous galvanostatic charging/discharging rates (corresponding to various current densities shown in FIG. 6a);

FIG. 6c shows the extrapolated specific energy versus specific power of a predicted 18650 lithium-ion battery with a scaled-up multilayer anode having the various channel array pitches shown in FIG. 6a. These extrapolated batteries are compared against a commercial lithium-ion battery (MoliCel ICR18650J) with the same cathode (LiCoO₂) and predicted ratio of capacity in the anode and cathode of 1 Ah to 1.15 Ah respectively (black square). While significantly improving the specific energy of the battery, limitations related to the maximum stable current density for the cathode may inhibit achieving the maximum specific power;

FIG. 6d shows the extrapolated specific energy versus specific power of a predicted 18650 lithium-ion battery with a scaled-up multilayer anode having the various channel array pitches shown in FIG. 6a. These extrapolated batteries are compared against a commercial lithium-ion battery (A123 APR18650) with the same cathode (LiFePO₄) and predicted ratio of capacity in the anode and cathode of 1 Ah to 2.4 Ah respectively (black square);

FIG. 7a shows cyclic voltammetry of exemplary (110) silicon wafers coated with copper or polyethylene and copper;

FIG. 7b shows galvanostatic charge/discharge cycling of a multilayer anode coated with copper and polyethylene (PE), where the PE layer does not contain channels;

FIG. 8a shows a top-down SEM image of a Cu/Si/Cu anode and corresponding secondary ion mass spectrometry before galvanostatic charge/discharge cycling. For the SIMS data the squares and circles correspond to silicon and copper respectively. The silicon layer was 4 μm thick and the channel array pitch was 1.15;

FIG. 8b shows a top-down SEM image of a Cu/Si/Cu anode and corresponding secondary ion mass spectrometry after one galvanostatic charge/discharge cycle. For the SIMS data the squares, circles, and triangles correspond to silicon, copper, and lithium respectively. The silicon layer was 4 μm thick and the channel array pitch was 1.15;

FIG. 8c a top-down SEM image of a Cu/Si/Cu anode and corresponding secondary ion mass spectrometry after five galvanostatic charge/discharge cycles. For the SIMS data the squares, circles, and triangles correspond to silicon, copper, and lithium respectively. The silicon layer was 4 μm thick and the channel array pitch was 1.15;

FIG. 8d shows a top down SEM image of the PE/Cu/Si anode referenced in FIG. 3a,b after 125 galvanostatic charge/discharge cycles;

FIG. 8e shows a zoomed in top down SEM images of the PE/Cu/Si anode shown in FIG. 8d after 125 galvanostatic charge/discharge cycles. The image shows that the integrity of the microstructure was maintained;

FIG. 8f shows a cross-section SEM image of a Cu/Si/Cu anode before galvanostatic charge/discharge cycling;

FIG. 8g shows a cross-section SEM image of a Cu/Si/Cu anode after galvanostatic charging;

FIG. 8h shows a cross-section SEM image of a Cu/Si/Cu anode after galvanostatic charge/discharge cycling;

FIG. 9 shows steps in an exemplary embossing process to fabricate multilayer anodes.

### DETAILED DESCRIPTION

Described herein is a multilayer micropore-modified silicon-based electrode for a Li-ion rechargeable battery that exploits materials selection and design of the microstructure to define transport and strain fields that enable high energy density and minimal capacity loss upon charge/discharge cycling. The silicon-based electrode is referred to as an anode or multilayer anode for clarity throughout the present disclosure, even though the anode may serve as the cathode in half-cells (when cycling versus lithium metal) and as the anode in full-cells (when cycling versus a commercial cathode).

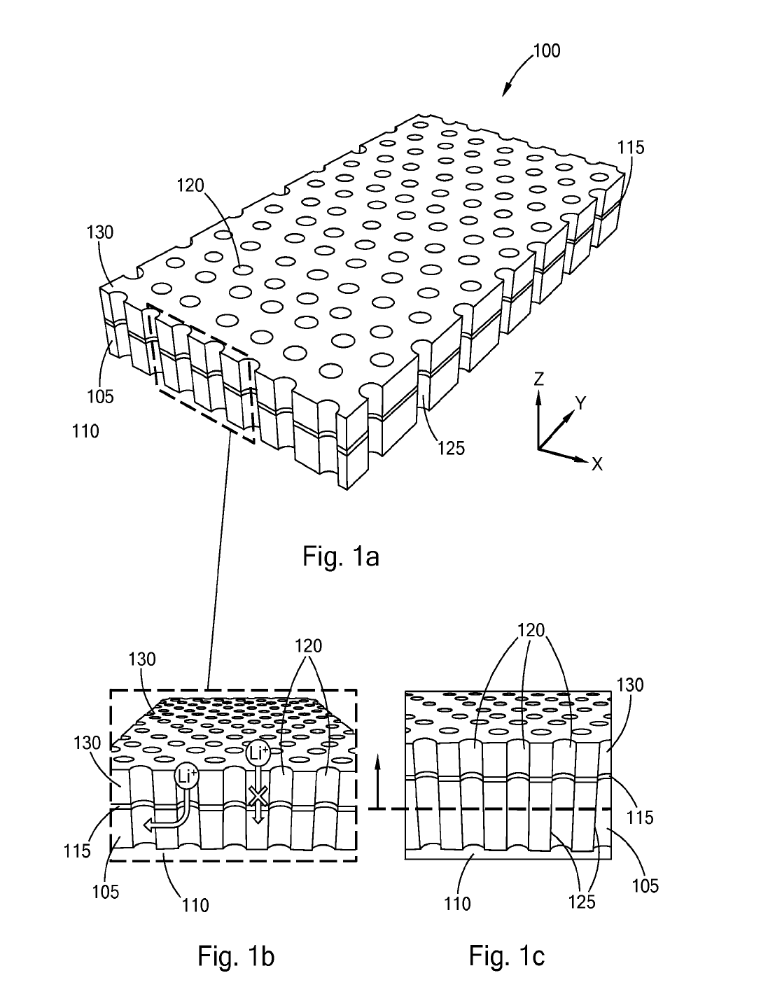

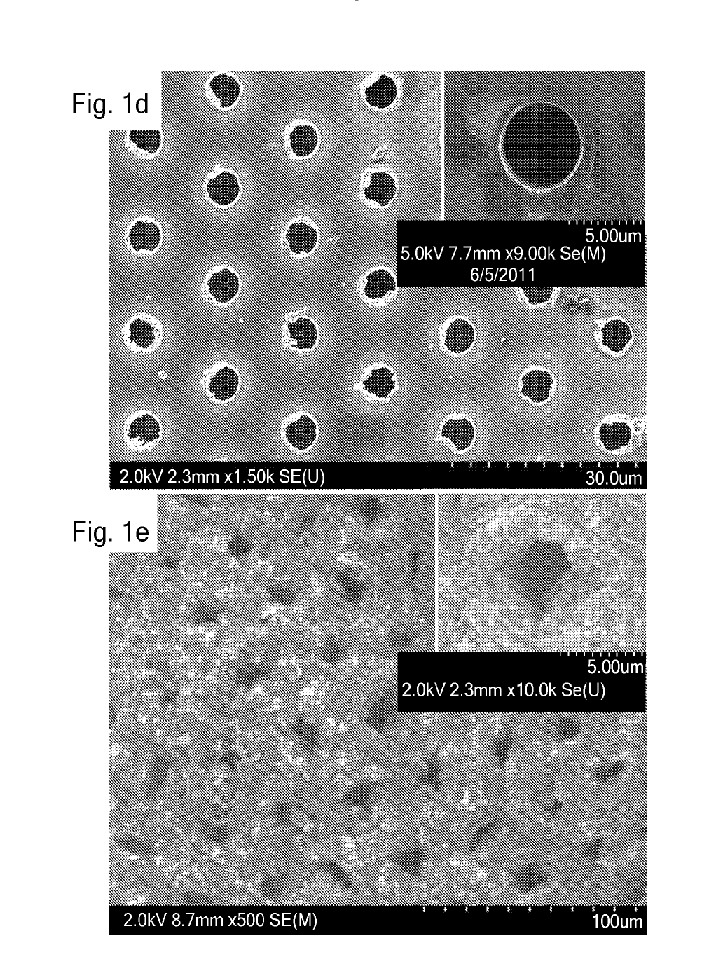

Referring to FIGS. 1a-1c, the multilayer anode 100 includes a silicon layer 105 on a substrate 110, an electrically conductive layer 115 overlying a top surface of the silicon layer 105, and a plurality of channels 120 extending through the electrically conductive layer 115 and the silicon layer 105 to the substrate 110, where the channels 120 define sidewalls 125 in the silicon layer 105. The electrically conductive layer 115, which functions as a current collector, may be a copper layer. The anode 100 may further include an optional polymer layer 130 on the electrically conductive layer 115, and the channels 120 may extend through the polymer layer 130. The electrically conductive layer 115 and the optional polymer layer 130 both inhibit lithium ion intercalation through the top surface of the silicon layer 105 during charging of a lithium-ion cell, and the lithium ion intercalation occurs instead through the sidewalls 125 of the silicon layer 105 defined by the channels 120.

According to one embodiment, the silicon layer may have a thickness of between about 1 μm and about 100 μm, and the electrically conductive layer is typically between about 1 nm and 200 nm in thickness. The polymer layer, which may be a polyethylene layer, is typically between about 1 μm and about 25 μm in thickness. The channels are aligned through all layers of the device. A second electrically conductive film may be coated on the other side of the silicon film, which is fixed to a support or substrate. The second electrically conductive film may be, for example, a copper film of 100 nm in thickness. The copper current collector and the polymer layer serve to inhibit or block electrochemical lithium insertion, as indicated schematically in FIG. 1b.

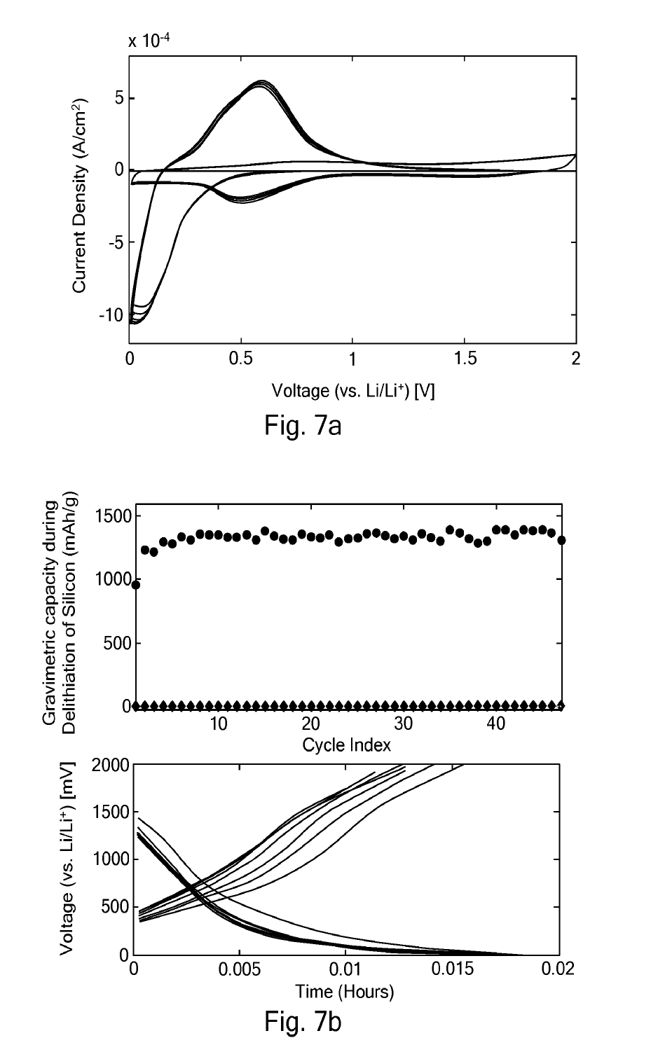

Although the thickness of the polymer layer can be widely varied, it has been observed that a 100 nm copper film and a 1.6 μm thick polyethylene layer can block lithium intercalation into the top of the silicon. 100 nm of copper alone reduces the current during lithiation measured during cyclic voltammetry by 89.9% (FIG. 7a). With the top surface substantially or completely blocked, electrochemical lithium insertion occurs primarily at the sidewalls of the silicon within the channels, as illustrated schematically in FIG. 1b. Another benefit of this structure is that ionic transport may be perpendicular to electronic transport and thus the electrode may be more evenly lithiated. Since the bottom of the silicon is fixed to a substrate, infilling of the channels with SEI may result in expansion perpendicular to the top surface of the silicon upon electrochemical lithium insertion, as illustrated in FIG. 1c. Large strains during (dis)charging are managed by controlling the direction of expansion, such that the polymer and copper layers provide mechanical support while maintaining electrical contact to the silicon.

The silicon layer may be made of single-crystalline (crystalline) silicon or polycrystalline silicon. In the case of crystalline silicon, the crystallographic orientation may be (100), (110), or another orientation. A polycrystalline silicon layer may include silicon particles in a binder, as discussed further below, where the binder includes an electrically conductive material such as copper.

As shown schematically in FIGS. 1a-1c, the channels 120 may be aligned substantially perpendicular to the top surface of the silicon layer 105. Other non-perpendicular alignments of the channels 120 with respect to the top surface of the silicon layer 105 are also possible, as long as they permit lateral transport of lithium ions into the silicon layer 105. The channels 120 may be arranged in an ordered array, such as a hexagonal or square array. The channels 120 may alternatively have a random arrangement.

Each channel may have a lateral dimension (e.g., a width or diameter) of between about 0.1 micron and about 10 microns, and the edge-to-edge spacing between adjacent channels is typically between about 1 micron and about 25 microns. As discussed in greater detail below, the size and spacing of the channels can influence the performance of the anode. Generally, the anodes have a channel array pitch (the ratio of the edge-to-edge distance between channels to the channel width/diameter) of between about 0.1 and 10, or between about 0.1 and 2.

FIG. 1d shows an SEM image (top view) of an exemplary thin-film silicon anode covered in copper and polymer prior to galvanostatic charge/discharge cycling. The channel array can be fabricated with minimal defects over large cm by cm areas. The anodes experience minimal degradation over 125 cycles; referring to FIG. 1e, even after cycling, the channel array can still clearly be seen.

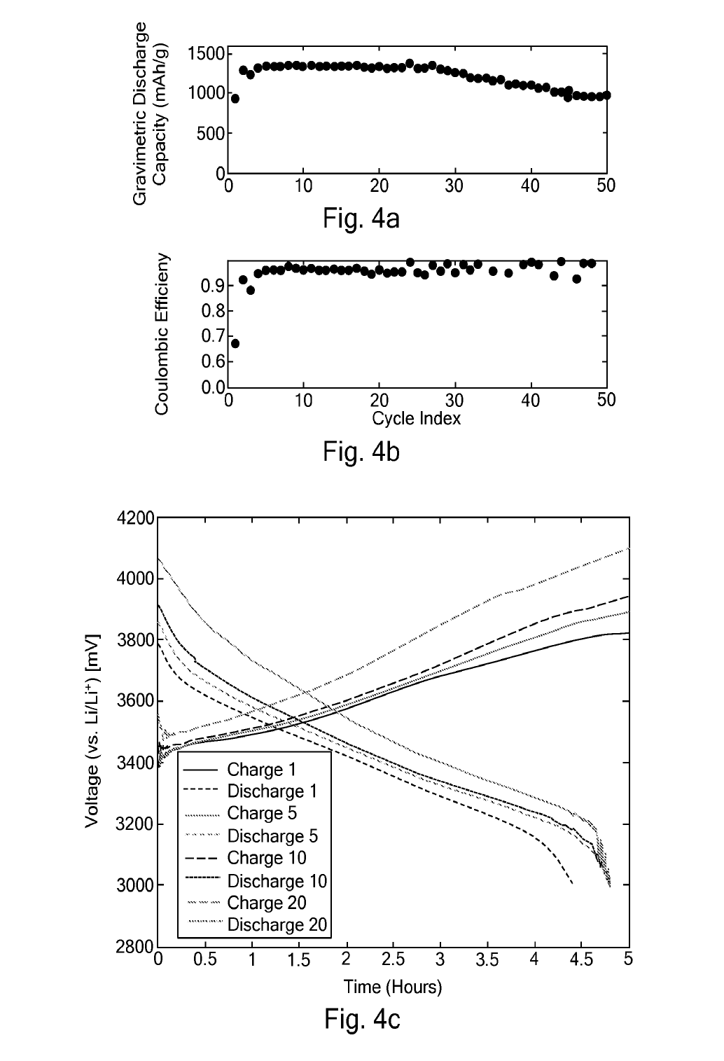

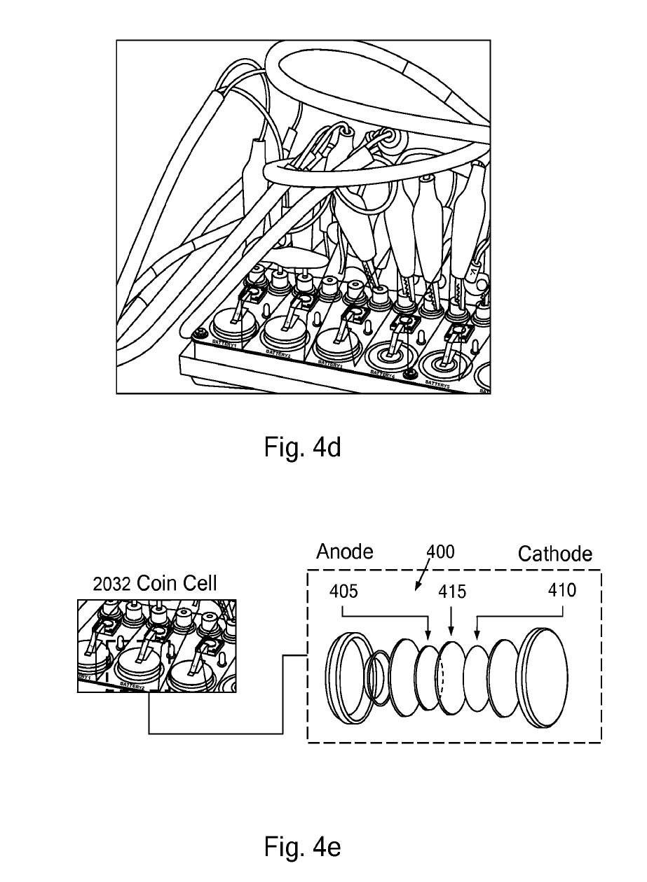

Using the multilayer anode, a lithium-ion rechargeable battery cell may be constructed. Referring to FIG. 4e, the lithium-ion cell 400 may include a first electrode 405, a second electrode 410, and an electrolyte (which may be incorporated within a separator) 415 in contact with the first electrode 405 and the second electrode 410, where the electrolyte conducts lithium ions. The first electrode 405 comprises a silicon layer 105 on a substrate 110, an electrically conductive layer 115 overlying a top surface of the silicon layer 105, and a plurality of channels 120 extending through the electrically conductive layer 115 and the silicon layer 105 to the substrate 110, as shown schematically in FIGS. 1a-1c. The channels 120 define sidewalls 125 in the silicon layer 105. As discussed above, the electrically conductive layer 115 inhibits lithium ion intercalation through the top surface of the silicon layer 105 during charging of the lithium-ion cell 400, and the lithium ion intercalation into the silicon layer 105 occurs through the sidewalls 125 defined by the channels 120.

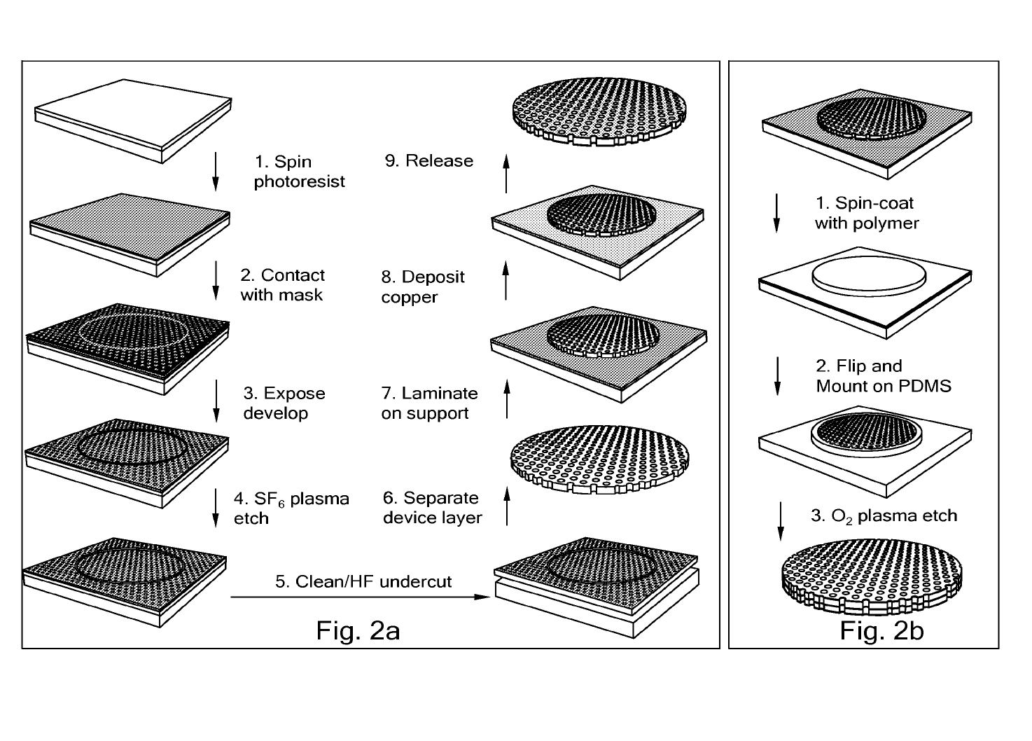

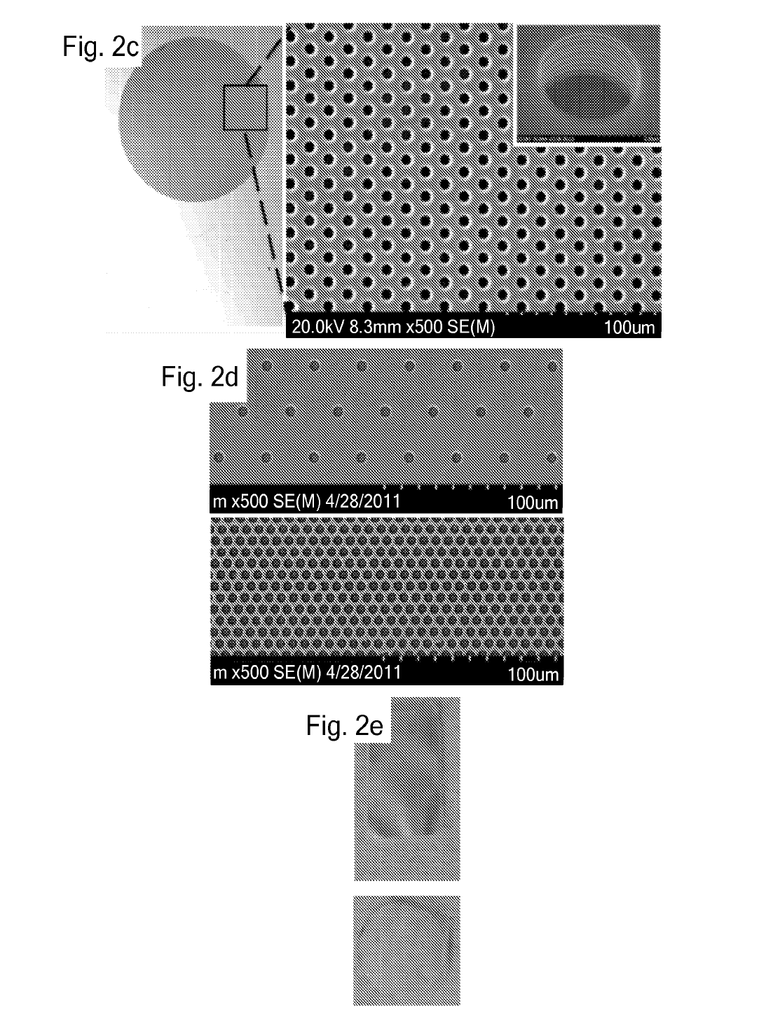

A possible fabrication scheme is described in detail below in reference to FIG. 2a. The fabrication process utilizes the inventors' expertise in photolithography and semiconductor fabrication to provide proof of concept. The anodes are fabricated by starting with a silicon-on-insulator (SOI) wafer that includes a thin silicon (device) layer on top of a silicon dioxide (BOX) layer and thick silicon (handle) layer; for the samples tested, the top silicon layer has an orientation of (100). The wafers are cleaved by notching the wafer with a diamond scribe. Nanostrip (Cyantek), which is a stabilized solution of sulfuric acid and hydrogen peroxide, acetone, and isopropyl alcohol are then used to clean the silicon.

Photoresist (e.g., AZ 5214 (Clariant)) is spun onto the samples (3000 rpm, 1500 rpm ramp, 30 seconds), pre-baked at 110° C. on a hot plate, placed in contact with a photolithography mask, and exposed using a mask aligner (MJB3 Mask Aligner, Suss Microtech). Two different types of masks are used. All the samples are exposed to UV light through a mask that contains circles of the desired array pitch that will eventually correspond to the channels. For coin cell samples, an additional exposure through a mask with a transparent ring results in a circular geometry of silicon being released upon HF undercutting. After the exposure(s), the samples are then developed using AZ 327MIF (Clariant) and postbaked at 110° C. for 7 minutes on a hot plate.

Plasma etching of the exposed regions of the silicon samples is performed using inductively-coupled-plasma reactive ion etching (ICPRIE) on an STS Mesc Multiplex Advanced Silicon Etcher. This instrument utilizes the Bosch process, a highly anisotropic form of plasma etching with high selectivity towards silicon over photoresist and silicon dioxide. Alternating between 7 second etch steps with 130 sccm SF₆ and 5 second passivation steps with 110 sccm C₄F₈, the exposed regions of silicon are etched substantially vertically through to the SiO₂ BOX layer. The samples are then cleaned by sonicating in acetone for 5 minutes at room temperature, sonicating in IPA for 5 minutes at room temperature, and then heating in RCA1 solution (1:1:5 ammonium hydroxide:H₂O₂:H₂O) for 10 minutes at 110° C. The BOX layer is etched via concentrated hydrofluoric acid (HF, 49%) such that the device layer is released from the SOI wafer. After the BOX layer is etched, some films may remain attached to the handle and may require the use of water or IPA for release.

The silicon is then transferred to a glass slide with photoresist (e.g., AZ 5214). Photoresist is spun onto a glass coverslip (same spinning parameters previously reported) and baked for 10 minutes at 110° C. on a hot plate. The silicon films are then transferred to the coverslip, and the silicon is baked for an additional 5 minutes. The silicon supported on the glass coverslip then has 100 nm of copper directionally deposited normal to the film using an electron beam deposition instrument (Temescal four pocket e-beam evaporation system). The coated samples are then cleaned in IPA, flipped over, and transferred to another glass slide coated with photoresist before an additional 100 nm of copper is deposited on the pristine silicon surface via electron beam deposition.

For some samples, additional fabrication steps may be utilized to add a polymer film, such as a polyethylene (PE) film, as an additional support and passivation layer. To deposit such a polymer film using spin coating, a PE film (Film-gard/Aldrich) may be dissolved in decahydronaphthalene (decalin), 8.0 wt %, and heated to 180° C. under reflux to maintain constant volume. All of the spin coating components (substrate, spinner chuck, pipet) may also be heated in an oven at 130° C. to reduce undulations in the film due to excessive cooling. The solution of PE in decalin may then be spun on the sample at 500 rpm for 1 minute. The samples are then flipped and transferred to a polydimethylsiloxane (PDMS) block such that the polymer is in contact with the PDMS. Upon oxygen plasma etching (March RIE), the copper and silicon act as an etch mask for the polymer during oxygen plasma etching. The etching results in channels registered through all three layers of the material and may be carried out at 150 W, 150 mTorr, and 20 sccm of O₂ for 4 hours.

FIG. 2c shows an actual device after ICPRIE etching of the silicon. The silicon is semi-transparent because of the 6 μm diameter channels which can be patterned in variety of different geometries. In this study, samples with different channel array pitches are fabricated by employing different masks in the photolithography step (FIGS. 2c,d). The initial testing of channel diameters and spacings were chosen based on the availability of masks. Device geometry, channel geometry, current collector material, polymer material, layer thicknesses, support, or morphology of the active material can be varied so long as the condition of laterally directed transport is satisfied. Samples having with different array pitches—ratio of edge-to-edge distance between the channels to the channel diameter—have been tested, including samples with an array pitch of approximately 1.15 (FIG. 2c), 3.72 (FIGS. 2d top), and 0.21 (FIG. 2d bottom). The SEM images of FIGS. 2c,d show that the volume fraction of silicon—and therefore the solid-state diffusion length to fully lithiate the silicon—can be widely varied.

Thin silicon ribbons for testing in a three-electrode cell (and possibly prismatic cells) as well as coin cells have been fabricated. Anodes for use in coin cells have a second exposure through a mask that results in the removal of an additional ring of photoresist during development; the inner diameter of this ring may be varied from a few microns to centimeters. ICPRIE and HF undercutting allow a circular device layer to be released from the SOI wafer.

### Cycling in a Three-Electrode Cell

A multilayer (PE/Cu/Si) anode, as depicted schematically in FIG. 1a, was galvanostatically charge/discharge cycled. The tested anode was fabricated using the steps shown in FIG. 2a-b, with two exceptions: there is no copper on the reverse side of the silicon, and the anode is supported on a glass slide by means of a “spin-on-glass” adhesive layer (Filmtronics 500F, spun at room temperature, 750 rpm for 8 seconds, cured at 130 C for 12 hours). Electrical contact to the current collector (copper layer) was achieved by drawing a contact from the copper layer on the device to a copper wire with a silver paste/epoxy. The sample was then coated with electrochemically inert epoxy (5 Minute Epoxy from Devcon) in order to define the active material.

This device was tested under argon atmosphere (<10 ppm O₂) in a glove box. Experiments were conducted using a three electrode electrochemical cell. The reference electrode and the counter electrode were lithium metal (Alfa Aesar). The electrolyte was 1.0 M lithium hexafluorophosphate (LiPF₆) salt in (1:1 w/w) ethylene carbonate (EC):diethyl carbonate (DEC). The cyclic voltammetry and galvanostatic charge/discharge cycling was conducted using a CHI660D galvanostat/potentiostat (CHInstruments). The PE/Cu/Si anode was galvanostatically charge/discharge cycled either between 2.0 V and 0.01 V or to approximately 1400 mAh/g (whichever limit was reached first). The limit for capacity was chosen because no cathodes currently can match anodes with capacities above about three times carbon. PE/Cu/Si anodes have a theoretical gravimetric capacity approximately 3 times greater than what is currently being tested. Twelve cycles were run at 140 mA/g (C/10) before increasing the 280 mA/g (C/5).

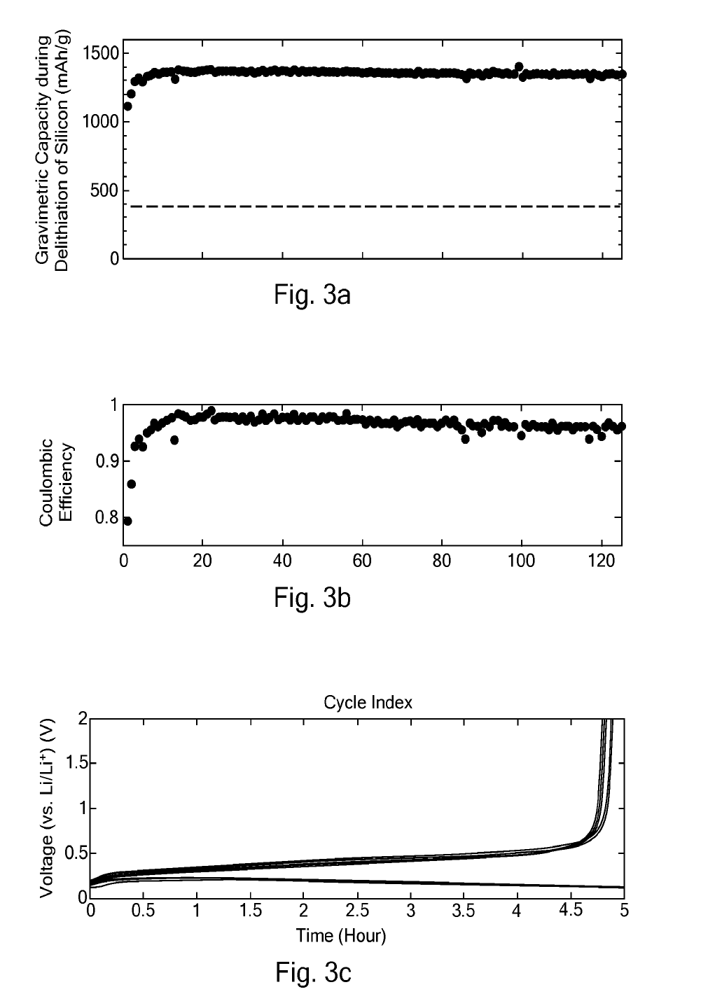

FIG. 3a depicts the discharge capacity per weight of silicon (gravimetric discharge capacity). The theoretical maximum capacity of carbon-based electrodes—the current industry standard—is 372 mAh/g. Minimal degradation in the gravimetric discharge capacity is shown for 125 galvanostatic charge/discharge cycles. FIG. 3b shows the evolution of coulombic efficiency—the ratio of Coulombs discharged to Coulombs inserted on each cycle. After a lower coulombic efficiency for first few cycles—most likely a result of solid-electrolyte formation on the surface of the electrode—a coulombic efficiency of >98% is maintained for over 125 cycles.

### Cycling in a Coin Cell

As described in detail below, experiments were also conducted using industry standard 2032 coin cells including exemplary Cu/Si/Cu anodes, polypropylene/polyethylene/polypropylene (PP/PE/PP) trilayer separators, and an LCO cathode with 1.0 M LiClO₄ in 1:1 (w/w) EC:DMC as described below in reference to FIGS. 4a-4c. A Cu/Si/Cu anode cycled with a LCO cathode had a similar level of sustainable performance as the half-cell experiments (lithium metal) when galvanostatically charged/discharged at C/5 (280 mA/g). >99% of the initial discharge capacity was maintained on the 90^{th} cycle. The average coulombic efficiency for the 10^{th}-90^{th} cycle is >99%. The battery is continuing to charge/discharge cycle.

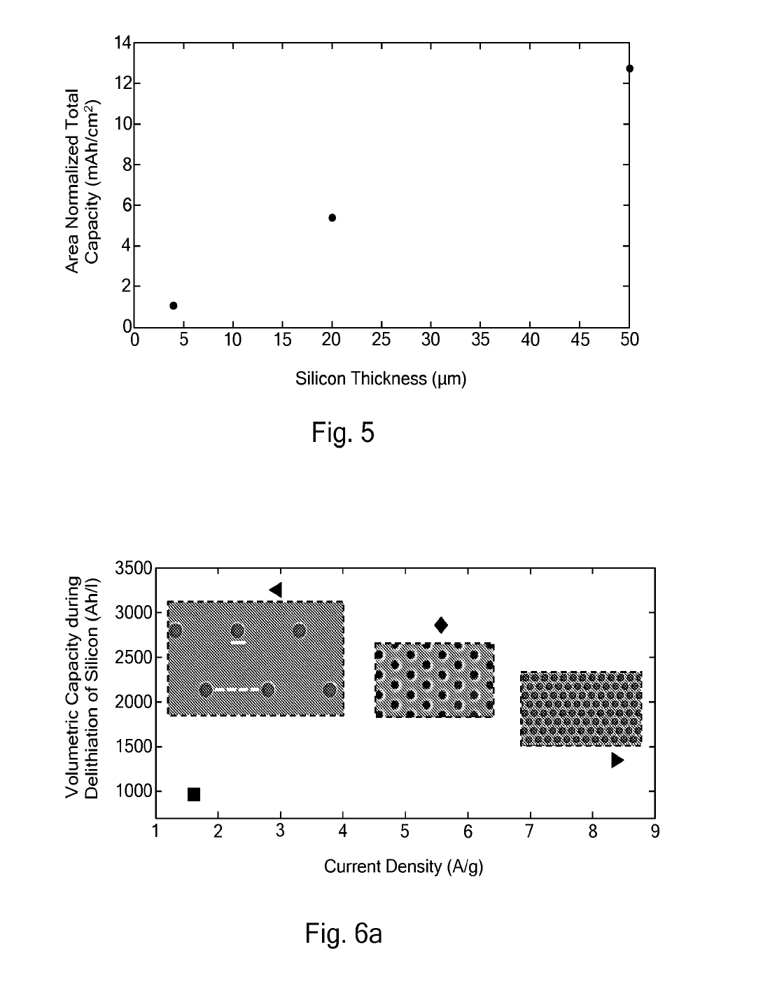

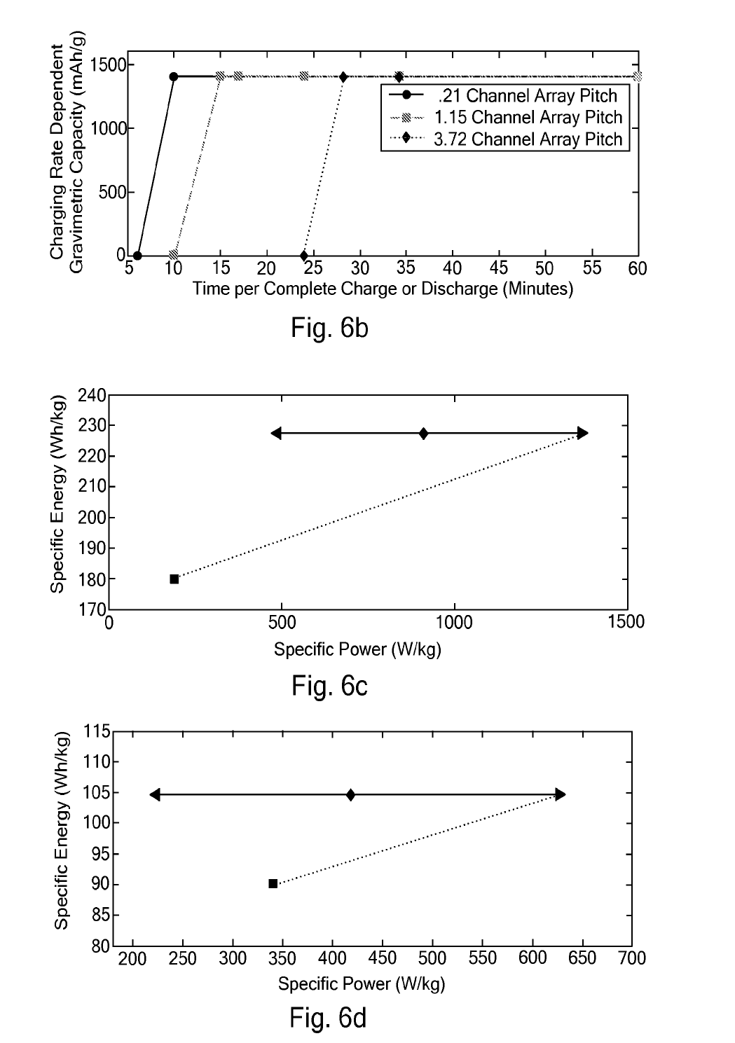

The limiting silicon thickness for this class of anode—and the maximum area normalized capacity (mAh/cm²) for an individual cell—were investigated by galvanostatically charge/discharge cycling anodes with silicon layer thicknesses from 4 μm to 50 μm, as described below in reference to FIG. 5. Anodes with a thickness of 50 μm had a maximum capacity of 12.74 mAh/cm². Additional testing was conducted using coin cells with lithium metal instead of an LCO cathode. The rate capability of these anodes was investigated by charging samples with different array pitches at different charging rates. The array pitch determines the amount of total active material as well as the longest solid-state lithium ion transport length through the silicon to charge the entire anode. For an array pitch that corresponds to 6 μm diameter channels with an edge-to-edge spacing of 7.5 μm, the maximum current density during continuous galvanostatic charging and discharging was 5.58 Ng (15 minutes to 1395 mA/g), as discussed below in reference to FIG. 6b. The maximum current density for the largest channel array pitch of 3.72 was 2.99 Ng corresponding to continuous galvanostatic charging or discharging to 1395 mAh/g in 28 minutes. The maximum current density for the smallest channel array pitch of 0.21 was 8.37 A/g (10 minutes to continuously galvanostatic charge or discharge to 1395 mAh/g).

### Cycling of Full Cells

Full coin cells with the multilayer (Cu/Si/Cu) anode and commercial cathodes were also cycled. Coin cells consisted of a metal casing, metal spacers, a plastic ring and a spring such that the anode, separator, and cathode are compressed together as well as the device is hermetically sealed when the cells are crimped (MTI International). The coin cells were fabricated and crimped in a glove box with argon. Cu/Si/Cu anodes were fabricated using the process flow shown in FIG. 2a. An LCO cathode (LiCoO₂) obtained from MTI International was utilized as the counter electrode. A trilayer PP/PE/PP separator was used (Celgard 2325). The coin cells were tested using 1M LiClO₄ in (1:3 by volume) EC: Dimethyl Carbonate (DMC). Open circuit potential was measured using a CHI 660D potentiostat (CHInstruments). Galvanostatic measurements were conducted using an 8 channel coin cell cycler (MTI International), as shown in FIG. 4d. Referring to FIGS. 4a-4c, the coin cell was galvanostatically charge/discharge cycled between 3 V and 4.2 V or to approximately 1400 mAh/g (whichever limit was reached first). This limit was chosen because no cathodes currently exist that can match anodes with capacities above the limit tested. The Cu/Si/Cu anodes have a theoretical gravimetric capacity approximately 3 times greater than what is currently being tested. Two formation cycles at 90 mA/g (C/15) were run before cycling the device at 280 mA/g (C/5). Minimal degradation in the gravimetric discharge capacity (>99% of the initial capacity is maintained) over 90 cycles. The coulombic efficiency for the 1^{st} cycle was 86%±12.1%. The average coulombic efficiency over the 10^{th} to the 90^{th} cycles was >99%. The battery is continuing to charge/discharge cycle.

### Area Normalized Capacity

Multilayer Cu/Si/Cu anodes having different silicon layer thicknesses were fabricated using the process flow shown in FIG. 2a. Different silicon on insulator (SOI) wafers with 4, 20, and 50 μm thick device layers were used (Ultrasil). Lithium metal was used as the counter-electrode in these experiments. The separator material is a standard, commercially available, tri-layered, polyolefin-based separator composed of polyethylene sandwiched between layers of polypropylene (Celgard 2325). The electrolyte used in the coin cell devices was composed of a lithium perchlorate salt (1.0 M, LiClO₄) in a 1:3 by volume mixture of ethylene carbonate and dimethyl carbonate. Open circuit potential was measured using a CHI 660D potentiostat (CH Instruments). Galvanostatic measurements were conducted using an 8 channel coin cell cycler (MTI International).

The coin cell was galvanostatically charge/discharge cycled either between 2 and 0.01 V or to approximately 1400 mAh/g (whichever limit was reached first). The limit for capacity was chosen because no cathodes currently can match anodes with capacities above about three times carbon. Cu/Si/Cu anodes have a theoretical gravimetric capacity approximately 3 times greater than what is currently being tested. Two formation cycles at 90 mA/g (C/15) were run before cycling the device at 280 mA/g (C/5).

Referring to 5a, the effect of varying device layer thickness has been explored through galvanostatically charge/discharge cycling Cu/Si/Cu anodes with 4, 20, and 50 pm thick silicon films. Increasing film thickness increases the amount of active material—and the total capacity (Ah)—in each cell. For clarity, the data was normalized to the sample area. Anodes for typical coin cells tested had active areas of 0.38-0.76 cm². For the 50 μm anode, this corresponds to a total capacity of 12.74 mAh/cm². The first two cycles a formation step run at C/15. The data points shown are for 4 μm and 20 μm devices obtained from cycling of coin cells with copper/silicon/copper layered anodes versus lithium metal cathodes. There is a limiting aspect ratio of the features (device thickness relative to channel diameter) that lowers the capacity of the anode. Further work will investigate how to mitigate such effects through increasing the channel size or decreasing the array pitch.

### Rate Study

Multilayer Cu/Si/Cu anodes having different channel array pitches were fabricated using the process flow shown in FIG. 2a. The channel array pitch was varied through changing the mask (Advanced Reproductions) used during photolithography. Lithium metal was used as the counter-electrode in these experiments. The separator material is a standard, commercially available, tri-layered, polyolefin-based separator composed of polyethylene sandwiched between layers of polypropylene (Celgard 2325). The electrolyte used in the coin cell devices was composed of a lithium perchlorate salt (1.0 M, LiClO₄) in a 1:3 by volume mixture of ethylene carbonate and dimethyl carbonate. Open circuit potential was measured using a CHI 660D potentiostat (CHInstruments). Galvanostatic measurements were conducted using an 8 channel coin cell cycler (MTI International). The coin cell was galvanostatically charge/discharge cycled either between 2.0 and 0.01 V or to approximately 1400 mAh/g (whichever limit was reached first). 1400 mAh/g represents a gravimetric capacity that outperforms all current cathodes and supplied more than triple the capacity of the current industry standard carbon anode materials. While the 1400 mAh/g limit was in place for this study, this figure can potentially be raised to take advantage of silicon's high theoretical capacity of 3579 mAh/g. The two formation cycles at 90 mA/g (C/15) were run before cycling the device at 280 mA/g (C/5).

Varying the pitch of the channels alters the amount of active material in the device and the maximum charge/discharge rate. Pitches of 0.21, 1.15, and 3.72 have been investigated corresponding with a channel diameter of 6 μm and the spacing of 1.21 μm, 7.5 μm, and 23.5 μm. FIG. 6a summarizes the capacity per volume versus maximum achievable stable, continuous current density for Cu/Si/Cu anodes with various channel array pitches (CAP)—the ratio of edge-to-edge distance between channels to the channel diameter. FIG. 6b shows the gravimetric discharge capacities after the 5^{th} cycles of devices based on pitches of 0.21, 1.15, and 3.72 and 4 μm thick silicon. Under galvanostatic charge/discharge cycling conditions, CAPs of 3.72, 1.15, and 0.21 were able to charge/discharge to 1400 mAh/g in 28.0 minutes (2.99 Ng), 15.0 minutes (5.58 Ng), and 10.0 minutes (8.37 A/g) respectively. FIG. 6c shows the extrapolated specific energy and power of 18650 lithium-ion batteries with a Cu/Si/Cu layered anodes having a channel array CAPs of either 0.21,1.15, or 3.72 (4 μm thick silicon) and LiCoO₂ cathode. These batteries are compared to a commercial ICR18650J (MoliCel) battery with the same cathode and predicted balancing of anode and cathode capacity (1 mAh of anode to 1.15 mAh of cathode). FIG. 6d shows the extrapolated specific energy and power of 18650 lithium-ion batteries with a Cu/Si/Cu layered anodes having a channel array CAPs of either 0.21,1.15, or 3.72 (4 μm thick silicon) and a LiFePO₄ cathode. These batteries are compared to a commercial APR18650 (A123) battery with the same cathode and predicted balancing of anode and cathode capacity (1 mAh of anode to 2.4 mAh of cathode). The maximum current density seen in the aforementioned experiments is possibly a result of limited diffusion rates of lithium through the bulk silicon leading to lithium-rich regions near the silicon/electrolyte interphase. These regions cannot be lithiated further within the potential ranges investigated.

### Copper and Polyethylene Coatings

The influence of copper and polyethylene coatings on the electrochemical activity of (110) silicon wafers was explored using cyclic voltammetry. Referring to FIG. 7a, peaks in the graph correspond with electrochemical reactions occurring at a given voltage.

The anodes were cycled between 2.0 V and 0.01 V using a lithium metal reference electrode and lithium metal counter electrode. The electrolyte was 1.0 M lithium hexafluoro-phosphate (LiPF₆) in ethylene carbonate (EC) and diethyl carbonate (DEC), 1:1 by volume. The experiment was under argon in a glove box (<10 ppm O₂). A 100 nm copper current collector was deposited by electron beam evaporation (Temescal four pocket E-Beam Evaporation System). For the (110) silicon wafer, the copper was deposited on the backside of the wafer, while all other samples had the copper deposited on the front of the wafer to mimic the layered structure of the multilayer anode design. All samples were covered with 5 Minute Epoxy (Devcon) to define the active material. The reduction in current measured during electrochemical lithium insertion (peak around 0.1 V) when coated with 100 nm thick copper was 89.9% and 99.2% when coated by 100 nm copper and 1.6 μm polyethylene (PE).

FIG. 7a (top) shows Galvanostatic cycling of a coin cell with a multilayer anode coated with copper and polyethylene was carried out between 2.0 V and 0.01 V (vs. Li/Li⁺). The counter electrode was lithium metal. Multilayer anodes were fabricated using the scheme described in FIG. 2a. 8 wt. % PE in decahydronaphthalene (decalin) was spun on the samples at 2000 rpm for 1 minute as described in FIG. 2b. No channels were etched into the PE. Coin cells were assembled under argon in a glove box. The separator was trilayer polypropylene/PE/polypropylene (Celgard 2325). 1.0 M lithium perchlorate (LiCIO₄) salt in EC:dimethyl carbonate (DMC), 1:3 by volume. Open circuit potentials were measured using a potentiostat (CH Instruments). Galvanostatic cycling was conducted using an 8 channel cycler (MTI International). The coin cell was galvanostatically charge/discharge cycled between 2.0 V and 0.01 V. Two formation cycles at 90 mA/g (C/15) were run before cycling the device at 280 mA/g (C/5). FIG. 7b (bottom) shows voltage vs. time for galvanostatic charge/discharge cycling.

Characterization of Multilayer Anodes after Selected Galvanostatic Charge/Discharge Cycles

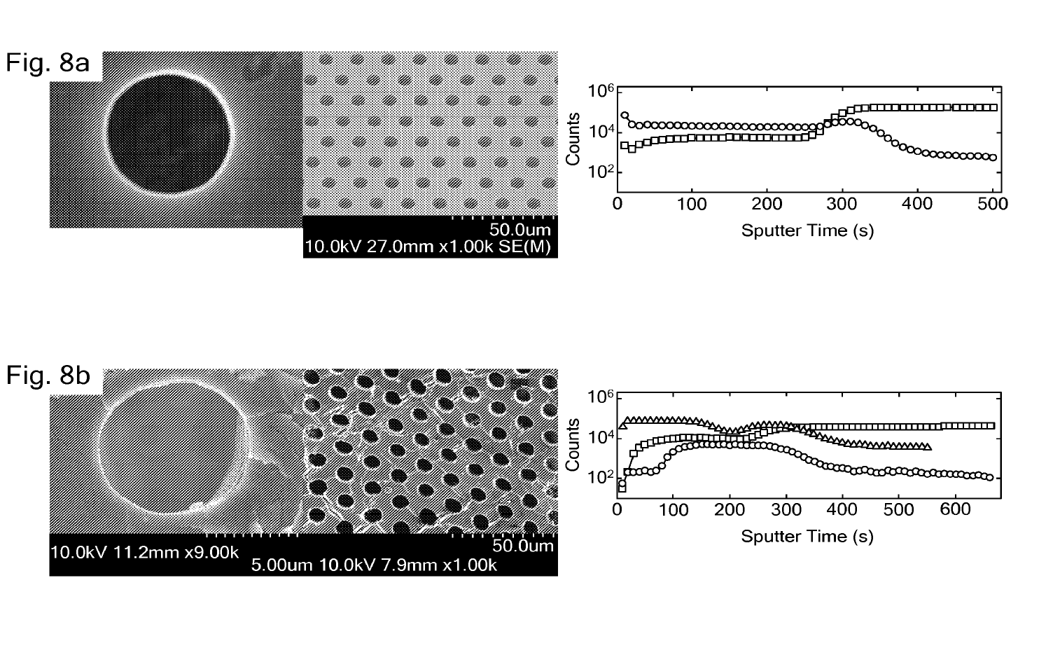

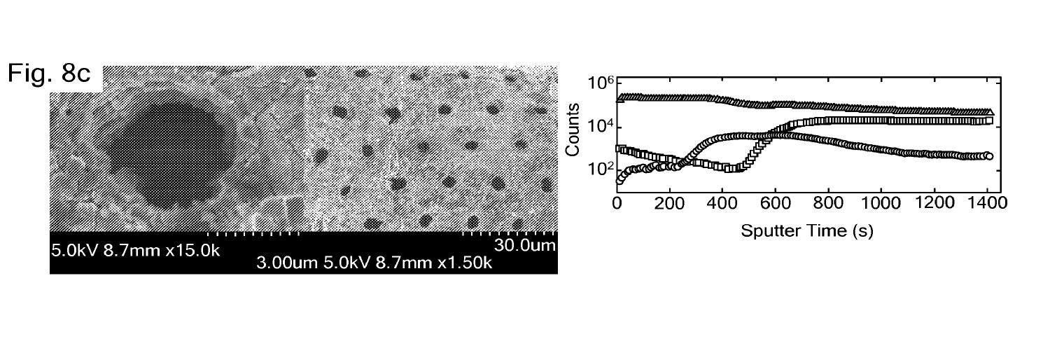

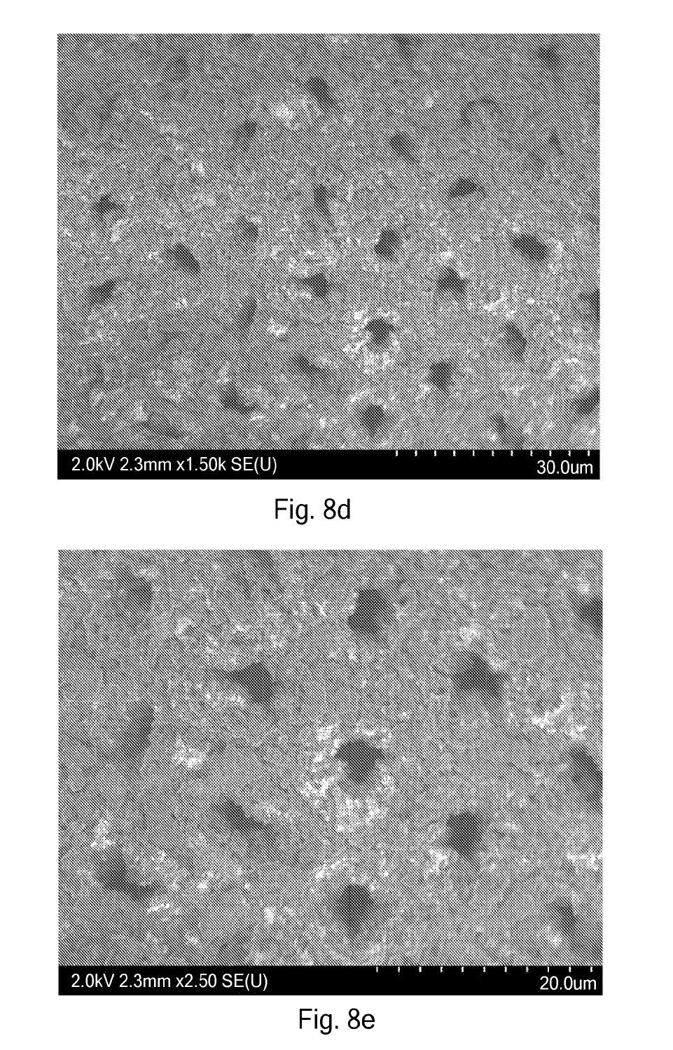

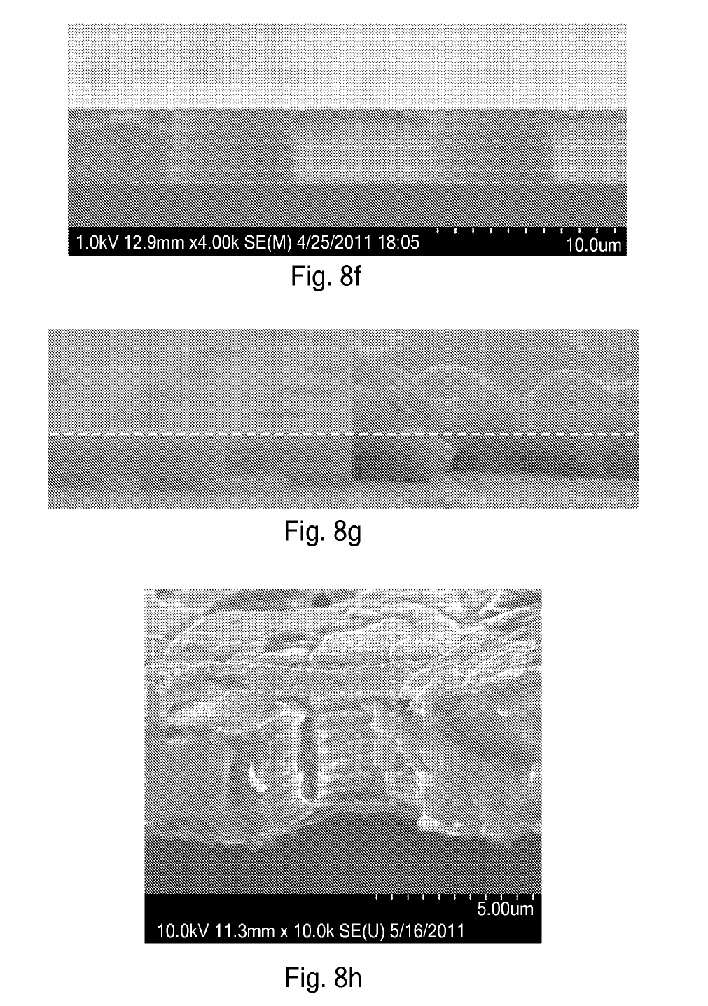

Scanning electron microscopy and secondary ion mass spectrometry were used to examine multilayer Cu/Si/Cu devices before and after up to 5 charge/discharge cycles. FIG. 8a depicts a typical Cu/Si/Cu device prior to cycling. FIGS. 8b and 8c show devices after 1 and 5 galvanostatic charge/discharge cycles, respectively, where lithium metal was used as the counter electrode and capacities for the silicon electrodes were limited to 1400 mAh/g. SIMS data provides a compositional depth profile for the samples shown in the SEM images. The probe was focused on a non-channel areas. The thickness of the silicon was 4 pm and the channel array pitch was 1.15.

The silicon membranes carry a thin oxide overlayer as initially fabricated, and it is on this layer that the Cu is deposited. Thermal curing of the SOG adhesive leads to interdiffusion of the Cu, generating a silicide and graded, oxide bearing interphase.

Galvanostatic cycling appears to generate additional structure: (a) a lithium rich SEI layer forms atop the electrode and coarsens during the first and fifth cycles; and (b) some lithium accumulates at the copper/silicon interface, suggesting the formation of a ternary Cu-Li-Si phase.

The top down SEM images comprising FIG. 8d are of the PE/Cu/Si sample referred to in FIGS. 3a-c. After galvanostatically charge/discharge cycling for over 125 cycles, the device maintained the overall microstructure with clearly defined channels.

FIG. 8e-g shows a Cu/Si/Cu electrode before galvanostatic cycling, after charging, and 5 charge/discharge cycles. Vertical expansion of the electrode is observed during galvanostatic charging. The microstructure remains intact after a few charge/discharge cycles.

### Embossing Approach

The multilayer anodes described herein may include a polycrystalline silicon layer in lieu of the single crystalline silicon layer described in the preceding examples. In such a case, the silicon layer may be composed of silicon particles with or without an additional binder being present. Such a structure may enable silicon-based anodes to have more bulk-like volumes of active material without critical losses in capacity retention or cycling efficiency. In such a device, a high weight fraction of silicon may be loaded into a mixture including a conductive binder material and then formed in a manner to produce the layered structure of the multilayer anodes. The performance enhancements (e.g., total gravimetric/volumetric capacity, capacity retention, and rate capabilities) realized in the studies of silicon-on-insulator derived films may be translated to more versatile systems composed of cheaper, more widely available materials.

The anode may be formed by embossing a pre-solid paste comprising nano- or micro-scale particles of silicon. The anode precursors may be produced by combining the as-prepared particles with a polymeric binder which may be further modified with conductive materials such as copper and carbon powders. The embossed, pre-solid materials may then be transformed into their final cured form by a thermal annealing cycle.

The composite nature of an active material formed in this way is attractive because it affords an ability to readily include additional components to improve the device performance.

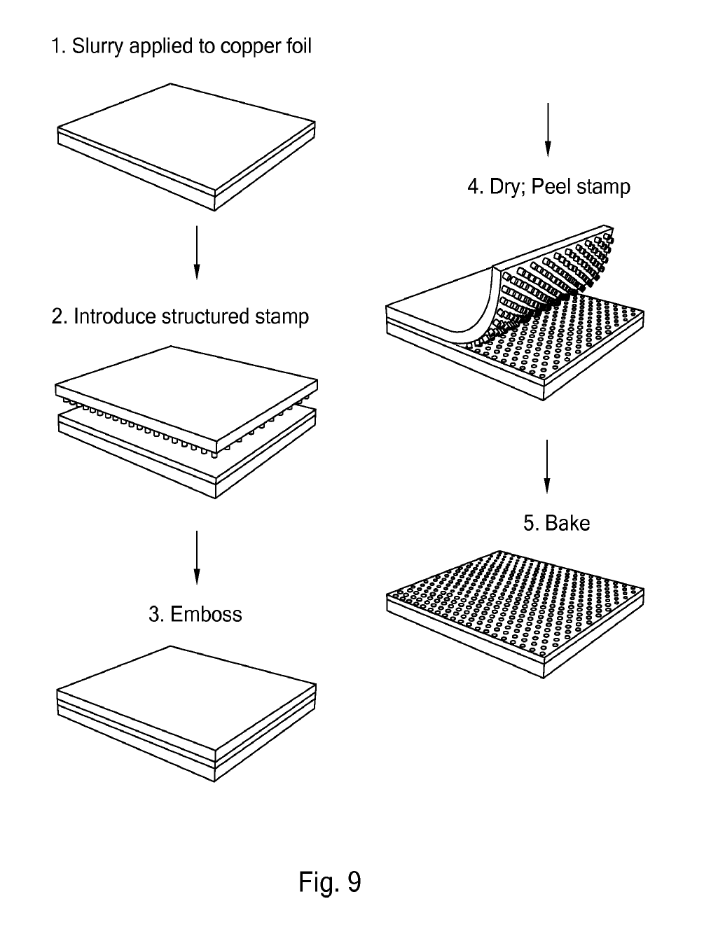

Powders and particle-based composites may be formed into multilayer anodes as noted in the example above, using an embossing technique with a structured polymer stamp (e.g., a PDMS stamp). The slurry may be set into the desired morphology by placing the patterned stamp in hard contact, drying, and peeling the stamp. Embossing as a technique for the fabrication of nano- or microstructured devices is set forth in U.S. Pat. No. 7,705,280, “Multispectral Plasmonic Crystal Sensors” to Nuzzo et al., which is hereby incorporated by reference in its entirety. A schematic of an exemplary procedure is shown in FIG. 9. Feature sizes, aspect ratios, and pitches are determined by the stamp material. In the case of PDMS, aspect ratios of 1:3 (feature width to height) and pitches of 1:20 (feature width to separation) are practical. Thus, films close to 20 μm in thickness may be produced using the feature sizes and pitches currently employed by the SOI derived anodes.

In this disclosure, the inventors have demonstrated that controlling lithium-ion transport—and subsequent strain fields—at the microscale can enable high capacity anodes with minimal capacity loss upon charge/discharge cycling. However, the design of channels and materials described herein are not intended to be limiting, but are merely provided as examples chosen for proof of concept. Other methods or forms of controlling lithium-ion transport and/or strain may achieve similar results. Furthermore, additional work can be done on these anodes to achieve higher capacities, coulombic efficiencies, and rate capabilities. The process flow for fabricating anodes demonstrated in this disclosure may be carried out using alternative techniques, such as embossing, that can produce devices of similar form factors and performance. A continuous anode with microscale features may be advantageous for limiting material loss and the eventual risk of shorting of the battery. Additional work is being conducted to confirm the safety of these devices.

Although the present invention has been described in considerable detail with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein.

Furthermore, the advantages described above are not necessarily the only advantages of the invention, and it is not necessarily expected that all of the described advantages will be achieved with every embodiment of the invention.

1. A silicon-based electrode for a lithium-ion cell, the electrode comprising:
a silicon layer on a substrate;
an electrically conductive layer overlying a top surface of the silicon layer; and
a plurality of channels extending through the electrically conductive layer and the silicon layer to the substrate, the channels defining sidewalls in the silicon layer;
wherein the electrically conductive layer inhibits lithium ion intercalation through the top surface of the silicon layer during charging of a lithium-ion cell, the lithium ion intercalation into the silicon layer occurring through the sidewalls defined by the channels.

2. The electrode of claim 1, wherein the channels are substantially perpendicular to the top surface of the silicon layer.

3. The electrode of claim 1, further comprising a polymer layer on the electrically conductive layer, wherein the polymer layer further inhibits lithium intercalation through the top surface of the silicon layer during charging of the cell.

4. The electrode of claim 3, wherein the channels extend through the polymer layer.

5. The electrode of claim 3, wherein the polymer layer comprises polyethylene.

6. The electrode of claim 1, wherein the silicon layer comprises crystalline silicon.

7. The electrode of claim 6, wherein the crystalline silicon has a (100) orientation.

8. The electrode of claim 1, wherein the silicon layer comprises polycrystalline silicon.

9. The electrode of claim 8, wherein the silicon layer comprises silicon particles in a binder.

10. The electrode of claim 9, wherein the binder comprises copper.

11. The electrode of claim 1, wherein the electrically conductive layer comprises copper.

12. The electrode of claim 1, wherein the channels are arranged in an ordered array.

13. (canceled)

14. The electrode of claim 1, wherein each channel has a lateral dimension of between about 0.1 micron and about 10 microns.

15. The electrode of claim 1, wherein a spacing between adjacent channels is between about 1 micron and about 25 microns.

16. The electrode of claim 1, wherein the channels comprise a channel array pitch of between about 0.1 and 10.

17. (canceled)

18. The electrode of claim 1, wherein the silicon layer comprises a thickness of between about 1 micron and about 100 microns.

19. A lithium-ion cell comprising:
a first electrode, a second electrode, and an electrolyte in contact with the first electrode and the second electrode, wherein the electrolyte conducts lithium ions and the first electrode comprises:
a silicon layer on a substrate;
an electrically conductive layer overlying a top surface of the silicon layer; and
a plurality of channels extending through the electrically conductive layer and the silicon layer to the substrate, the channels defining sidewalls in the silicon layer,
wherein the electrically conductive layer inhibits lithium ion intercalation through the top surface of the silicon layer during charging of the lithium-ion cell, the lithium ion intercalation into the silicon layer occurring through the sidewalls defined by the channels.

20. A method of charging a lithium-ion cell, the method comprising:
providing a first electrode, a second electrode, and an electrolyte in contact with the first electrode and the second electrode, wherein the electrolyte conducts lithium ions and the first electrode comprises: a silicon layer on a substrate; an electrically conductive layer overlying a top surface of the silicon layer; and a plurality of channels extending through the electrically conductive layer and the silicon layer to the substrate, the channels defining sidewalls in the silicon layer; and
intercalating lithium ions into the silicon layer through the sidewalls thereof, the lithium ions being substantially blocked from intercalation through the top surface of the silicon layer.

21. The method of claim 20, further comprising forming a solid electrolyte interface layer on the sidewalls of the silicon layer.

22. The method of claim 20, wherein the channels are aligned in a thickness direction substantially perpendicular to the top surface of the silicon layer, and wherein the silicon layer expands in the thickness direction during the intercalating.
